(19) United States
(12) Patent Application Publication
(10) Pub. No.: US 2015/0053242 A1
(43) Pub. Date: Feb. 26, 2015

(54) CLEANING METHOD

(71) Applicants: Tomohiro Watanabe, Oyama-shi (JP); Michiya Sunazuka, Oyama-shi (JP); Tutomu Yanagawa, Oyama-shi (JP)

(72) Inventors: Tomohiro Watanabe, Oyama-shi (JP); Michiya Sunazuka, Oyama-shi (JP); Tutomu Yanagawa, Oyama-shi (JP)

(21) Appl. No.: 13/699,427

(22) PCT Filed: May 17, 2011
(86) PCT No.: PCT/JP2011/061312

§ 371 Date: Jan. 31, 2013

(30) Foreign Application Priority Data
May 24, 2010 (JP) 2010-118371

(51) Int. Cl. B08B 3/02; G03G 21/00

(52) U.S. Cl. CPC B08B 3/022; G03G 21/0005
USPC 134/32; 134/151

(57) ABSTRACT

The cleaning method includes a cleaning step of, in a state in which an upper cleaning liquid 3 is spouted downward from an upper nozzle 2 arranged on an upper side of a work 10 and a lower cleaning liquid 5 is spouted upward from a lower nozzle 4 arranged on a lower side of the work 10, cleaning at least an upper surface of the work 10 among the upper surface of the work and an outer peripheral surface 10b of the work 10 with the upper cleaning liquid 3 and cleaning a lower surface 10c of the work 10 with the lower cleaning liquid 5 by relatively moving the work 10 in a horizontal direction with respect to both the upper nozzle 2 and the lower nozzle 4. At the cleaning step, the upper cleaning liquid 2 and the lower cleaning liquid 5 are spouted from the upper nozzle 2 and the lower nozzle 4, respectively, so that the upper cleaning liquid 3 always hits against at least a part of a region formed by the upper surface 10a of the work 10 and the outer peripheral surface 10c of the work 10 when the lower cleaning liquid 5 hits against the lower surface 10c of the work 10.

### TECHNICAL FIELD

The present invention relates to a cleaning method and a cleaning device for cleaning a work such as a photoconductive drum substrate.

### BACKGROUND TECHNIQUE

A cylindrical substrate for use in a photoconductive drum for an electrophotographic device, such as, e.g., a copying machine, a printer, and a facsimile device, i.e., a photoconductive drum substrate, is made of metal, such as, e.g., aluminum or its alloy. An organic photoreceptor layer is formed on an outer peripheral surface of the photoconductive drum substrate. A peripheral edge of each axial end face of the photoconductive drum substrate is chamfered by cutting.

In such a substrate, the entire surface of the substrate is subjected to a cleaning process before forming an organic photoreceptor layer to form an excellent organic photoreceptor layer thereon. With this cleansing process, extraneous substances, such as, e.g., chips or oil, adhered to the substrate will be removed.

As a published document disclosing a method of cleaning a substrate, there exists, for example, Japanese Unexamined Laid-open Patent Application Publication No. 2006-106380 (Patent Document 1). In this published document, as a method of cleaning a substrate, spray cleaning in which a substrate is cleaned with a cleaning liquid sprayed from a nozzle is employed. Other published documents include, e.g., Japanese Unexamined Laid-open Patent Application Publication No. 2003-262964 (Patent Document 2).

In general, when cleaning a lower surface of a work such as a photoconductive drum substrate by a spray cleaning method, in a state in which the work is supported by a work supporting member, a cleaning liquid is sprayed upward from a nozzle arranged on the lower side of the work. The lower surface of the work is cleaned by the lower cleaning liquid.

### PRIOR ART

### Patent Document

Patent Document 1: Japanese Unexamined Laid-open Patent Application Publication No. 2006-106380

Patent Document 2: Japanese Unexamined Laid-open Patent Application Publication No. 2003-262964

### SUMMARY OF THE INVENTION

### Problems to be Solved by the Invention

According to this cleaning method, however, at the time of cleaning a lower surface of a work, in some cases the work rises up from the work supporting member when the lower cleaning liquid spouted from the lower nozzle hits against the lower surface of the work. This makes it difficult to sufficiently clean the lower surface of the work. Further, when the lower cleaning liquid stops hitting the lower surface of the work that rose up, the work goes down under its own weight to collide with the work supporting member, which may cause damages of the lower surface of the work.

The present invention was made in view of the aforementioned problems, and aims to provide a cleaning method and a cleaning device for the cleaning method which can prevent a work from rising up at the time of performing a spray cleaning of a lower surface of a work such as a photoconductor drum substrate. Other objects and advantages of the present invention will be apparent from the following preferred embodiments.

### Means for Solving the Problems

The present invention provides the following means.

[1] A cleaning method comprising:

a cleaning step of, in a state in which an upper cleaning liquid is spouted downward from an upper nozzle arranged on an upper side of a work and a lower cleaning liquid is spouted upward from a lower nozzle arranged on a lower side of the work, cleaning at least an upper surface of the work among the upper surface of the work and an outer peripheral surface of the work with the upper cleaning liquid and cleaning a lower surface of the work with the lower cleaning liquid by relatively moving the work in a horizontal direction with respect to both the upper nozzle and the lower nozzle, wherein

at the cleaning step, the upper cleaning liquid and the lower cleaning liquid are spouted from the upper nozzle and the lower nozzle, respectively, so that the upper cleaning liquid always hits against at least a part of a region formed by the upper surface of the work and the outer peripheral surface of the work when the lower cleaning liquid hits against the lower surface of the work.

[2] The cleaning method as recited in the aforementioned Item 1, wherein

an arranged position of the upper nozzle and an arranged position of the lower nozzle are shifted in a plane view; and

at the cleaning step, the upper cleaning liquid and the lower cleaning liquid are spouted from the upper nozzle and the lower nozzle, respectively, so that the upper cleaning liquid and the lower cleaning liquid do not interfere with each other.

[3] The cleaning method as recited in the aforementioned Item 1 or 2, wherein

a spout flow amount of the upper cleaning liquid to be spouted from the upper nozzle per unit time is larger than a spout flow amount of the lower cleaning liquid to be spouted from the lower nozzle per unit time.

[4] The cleaning method as recited in any one of the aforementioned Items 1 to 3, wherein

the work is a cylindrical member and is arranged with an axis thereof arranged vertically; and

at the cleaning step, the upper surface, the outer peripheral surface and an inner peripheral surface of the work are cleaned with the upper cleaning liquid, and the lower surface and the inner peripheral surface of the work are cleaned with the lower cleaning liquid.

[5] The cleaning method as recited in any one of aforementioned Items 1 to 4, wherein

the upper nozzle and the lower nozzle are each constituted by a flat spray nozzle; and

at the cleaning step, the upper cleaning liquid and the lower cleaning liquid are spouted from the upper nozzle and the lower nozzle, respectively, in a fan-shaped film-like manner.

[6] The cleaning method as recited in the aforementioned Item 5, wherein

at the cleaning step, the upper cleaning liquid and the lower cleaning liquid are spouted from the upper nozzle and the lower nozzle, respectively, so that a spout spreading direction of the upper cleaning liquid and a spout spreading direction of the lower cleaning liquid become parallel with each other in a plane view.

[7] The cleaning method as recited in aforementioned Item 5 or 6, wherein

in a plane view, a plurality of works are arranged in a direction perpendicular to a relative moving direction of the works; and

in a plane view, a plurality of upper nozzles and a plurality of lower nozzles are arranged alternatively in the direction perpendicular to the relative moving direction of the works.

[8] The cleaning method as recited in any one of aforementioned Item 5 to 7, wherein

in a plane view, the upper nozzle is arranged outside a relative moving region of the work, and the lower nozzle is arranged inside the relative moving region of the work.

[9] The cleaning method as recited in any one of aforementioned Items 5 to 8, wherein

at the cleaning step, in a plane view, the upper cleaning liquid and the lower cleaning liquid are spouted from the upper nozzle and the lower nozzle, respectively, so that both a spout spreading direction of the upper cleaning liquid and a spout spreading direction of the lower cleaning liquid become oblique with respect to the relative moving direction of the works.

[10] The cleaning method as recited in any one of aforementioned Items 5 to 9, wherein

in a plane view, a plurality of the works are arranged in plural lines in the relative moving direction of the works and arranged in plural rows in the direction perpendicular to the relative moving direction of the works; and

at the cleaning step, the upper cleaning liquid is spouted so that the upper cleaning liquid hits against at least one work arranged in one of the adjacent two work lines and at least one work arranged in the other of the adjacent two work lines.

[11] The cleaning method as recited in any one of aforementioned Items 5 to 10, wherein

a spout spreading width of the upper cleaning liquid to be spouted from the upper nozzle at the work arranged position is larger than a spout spreading width of the lower cleaning liquid to be spouted from the lower nozzle at the work arranged position.

[12] The cleaning method as recited in any one of aforementioned Items 1 to 11, wherein

a vertical directional distance between the lower nozzle and the work is shorter than a vertical directional distance between the upper nozzle and the work.

[13] The cleaning method as recited in any one of claims 1 to 12, wherein

the work is a photoconductive drum substrate.

[14] A cleaning device comprising:

an upper nozzle arranged on an upper side of a work and configured to spout an upper cleaning liquid downward;

a lower nozzle arranged on a lower side of the work and configured to spout a lower cleaning liquid upward; and

a driving means configured to move the work in a horizontal direction relative to both the upper and lower nozzles; wherein

it is configured such that in a state in which an upper cleaning liquid is spouted from the upper nozzle and a lower cleaning liquid is spouted from the lower nozzle, at least an upper surface of the work among the upper surface of the work and an outer peripheral surface of the work are cleaned with the upper cleaning liquid and a lower surface of the work is cleaned with the lower cleaning liquid by relatively moving the work with respect to the upper nozzle and the lower nozzle with the driving means; and

the upper cleaning liquid and the lower cleaning liquid are spouted from the upper nozzle and the lower nozzle, respectively, so that the upper cleaning liquid always hits against at least a part of a region formed by the upper surface of the work and the outer peripheral surface of the work when the lower cleaning liquid hits against the lower surface of the work.

In the cleaning device recited in Item [14], the following structure can be employed.

[15] The cleaning device as recited in Item [14], wherein

in a plane view, an arranged position of the upper nozzle and an arranged position of the lower nozzle are shifted, and the upper cleaning liquid and the lower cleaning liquid are spouted from the upper nozzle and the lower nozzle, respectively, so that the upper cleaning liquid and the lower cleaning liquid do not interfere with each other.

[16] The cleaning device as recited in Item [14] or [15], wherein

a spout flow amount for the upper cleaning liquid to be spouted from the upper nozzle per unit of time is larger than a spout flow amount of the lower cleaning liquid to be spouted from the lower nozzle per unit of time.

[17] The cleaning device as recited in any one of Items [14] to [16], wherein

the work is a cylindrical member and is arranged with an axis thereof arranged vertically; and

the upper surface, the outer peripheral surface, and an inner peripheral surface of the work are cleaned with the upper cleaning liquid and the lower surface and the inner peripheral surface of the work are cleaned with the lower cleaning liquid.

[18] The cleaning device as recited in any one of Items [14] to [17], wherein

the upper nozzle and the lower nozzle are each constituted by a flat spray nozzle;

the upper cleaning liquid and the lower cleaning liquid are spouted from the upper nozzle and the lower nozzle, respectively, in a fan-shaped film-like manner.

[19] The cleaning device as recited in Item [18], wherein

in a plane view, the upper cleaning liquid and the lower cleaning liquid are spouted from the upper nozzle and the lower nozzle, respectively, so that a spout spreading direction of the upper cleaning liquid and a spout spreading direction of the lower cleaning liquid become parallel with each other.

[20] The cleaning device as recited in Items [18] or [19], wherein

in a plane view, a plurality of works are arranged in a direction perpendicular to a relative moving direction of the works; and

in a plane view, a plurality of upper nozzles and a plurality of lower nozzles are arranged alternatively in the direction perpendicular to the relative moving direction of the works.

[21] The cleaning device as recited in any one of Items [18] to [20], wherein

in a plane view, the upper nozzle is arranged outside a relative moving region of the work, and the lower nozzle is arranged inside the relative moving region of the work.

[22] The cleaning device as recited in any one of Items [18] to [21], wherein

in a plane view, the upper cleaning liquid and the lower cleaning liquid are spouted from the upper nozzle and the lower nozzle, respectively, so that both a spout spreading direction of the upper cleaning liquid and a spout spreading direction of the lower cleaning liquid become oblique with respect to the relative moving direction of the works.

[23] The cleaning device as recited in any one of Items [18] to [22], wherein

a plurality of the works are arranged in plural lines in the relative moving direction of the works and arranged in plural rows in a direction perpendicular to the relative moving direction of the works; and

the upper cleaning liquid is spouted so that the upper cleaning liquid hits against at least one work arranged in one of the adjacent two work lines and at least one work arranged in the other of the adjacent two work lines.

[24] The cleaning device as recited in any one of Items [18] to [23], wherein

a spout spreading width of the upper cleaning liquid to be spouted from the upper nozzle at the work arranged position is larger than a spout spreading width of the lower cleaning liquid to be spouted from the lower nozzle at the work arranged position.

[25] The cleaning method as recited in any one of Items [14] to [24], wherein

a vertical directional distance between the lower nozzle and the work is shorter than a vertical directional distance between the upper nozzle and the work.

[26] The cleaning method as recited in any one of Items [14] to [25], wherein

the work is a photoconductive drum substrate.

### Effects of the Invention

The present invention exerts the following effects.

According to the cleaning method recited in Item [1], by spouting the upper cleaning liquid and the lower cleaning liquid from the upper nozzle and the lower nozzle respectively so that, when the lower cleaning liquid hits against the lower surface of the work, the upper cleaning liquid always hits at least a part of a region formed by the upper surface and the outer peripheral surface of the work, the work can be prevented from rising up. This enables assured cleaning of the lower surface of the work and prevents damages to the lower surface of the work.

According to the cleaning method recited in the aforementioned Item [2], by spouting the upper cleaning liquid and the lower cleaning liquid from the upper nozzle and the lower nozzle, respectively, so that the upper cleaning liquid and the lower cleaning liquid do not interfere with each other, the detergency of the upper cleaning liquid and that of the lower cleaning liquid can be improved.

According to the cleaning method recited in the aforementioned Item [3], the work can be assuredly prevented from rising up because the spout flow amount of the upper cleaning liquid from the upper nozzle is larger than the spout flow amount of the lower cleaning liquid from the lower nozzle.

According to the cleaning method recited in the aforementioned Item [4], even if the work is a cylindrical member having a small diameter, the entire surface of the work, i.e., the upper surface, the outer peripheral surface, the lower surface, and the inner peripheral surface of the work can be cleaned.

According to the cleaning method recited in the aforementioned Item [5], since the upper nozzle and the lower nozzle are each constituted by a flat spray nozzle, and the upper cleaning liquid and the lower cleaning liquid are respectively spouted from the upper nozzle and the lower nozzle in a fan-shaped film-like manner, the detergency of the upper cleaning liquid and that of the lower cleaning liquid each can be further improved.

According to the cleaning method recited in the aforementioned Item [6], by spouting the upper cleaning liquid and the lower cleaning liquid from the upper nozzle and the lower nozzle, respectively, so that a spout spreading direction of the upper cleaning liquid and a spout spreading direction of the lower cleaning liquid become parallel with each other, possible interference of the upper cleaning liquid and the lower cleaning liquid can be assuredly prevented, and furthermore, the upper cleaning liquid and the lower cleaning liquid can be spouted in a closely arranged manner, which enables effective cleaning of the work and reduction of the size of the cleaning device.

According to the cleaning method recited in the aforementioned Item [7], a plurality of works can be cleaned collectively.

According to the cleaning method recited in the aforementioned Item [8], the upper surface and the outer peripheral surfaces of the work can be assuredly cleaned with the upper cleaning liquid, and even if the work is cylindrical in shape, the lower surface and the inner peripheral surface of the cylindrical work can be assuredly cleaned with the lower cleaning liquid.

According to the cleaning method recited in the aforementioned Item [9], when a plurality of works are arranged in a direction perpendicular to the relative moving direction of the works, two adjacent works can be cleaned with the upper cleaning liquid spouted from one upper nozzle. This enables efficient cleaning of works.

According to the cleaning method recited in the aforementioned Item [10], more works can be cleaned collectively, so the works can be efficiently cleaned.

According to the cleaning method recited in the aforementioned Item [11], the spouting condition of the upper cleaning liquid and that of the lower cleaning liquid as recited in the aforementioned Item [1] can be assuredly realized.

According to the cleaning method recited in the invention [12], the lower surface of the work can be assuredly cleaned.

According to the cleaning method recited in the aforementioned Item [13], a photoconductive drum substrate as a work can be cleaned.

The cleaning device recited in the aforementioned Item [14] can be used for the cleaning method recited in the aforementioned Item [1].

The cleaning devices recited in the aforementioned Items [15] to [26] can be used for the cleaning method recited in the aforementioned Items [2] to [13].

### BRIEF EXPLANATION OF THE DRAWINGS

FIG. 1 is a plane view showing a cleaning method according to an embodiment of the present invention in a state in which works are being cleaned.

FIG. 2 is a front view as seen from the front side with respect to a work moving direction.

FIG. 3 is a perspective view of a work supporting member.

FIG. 4 is a half-sectional side view of a work.

### EMBODIMENTS FOR CARRYING OUT THE INVENTION

Next, an embodiment of the present invention will be explained with reference to the drawings.

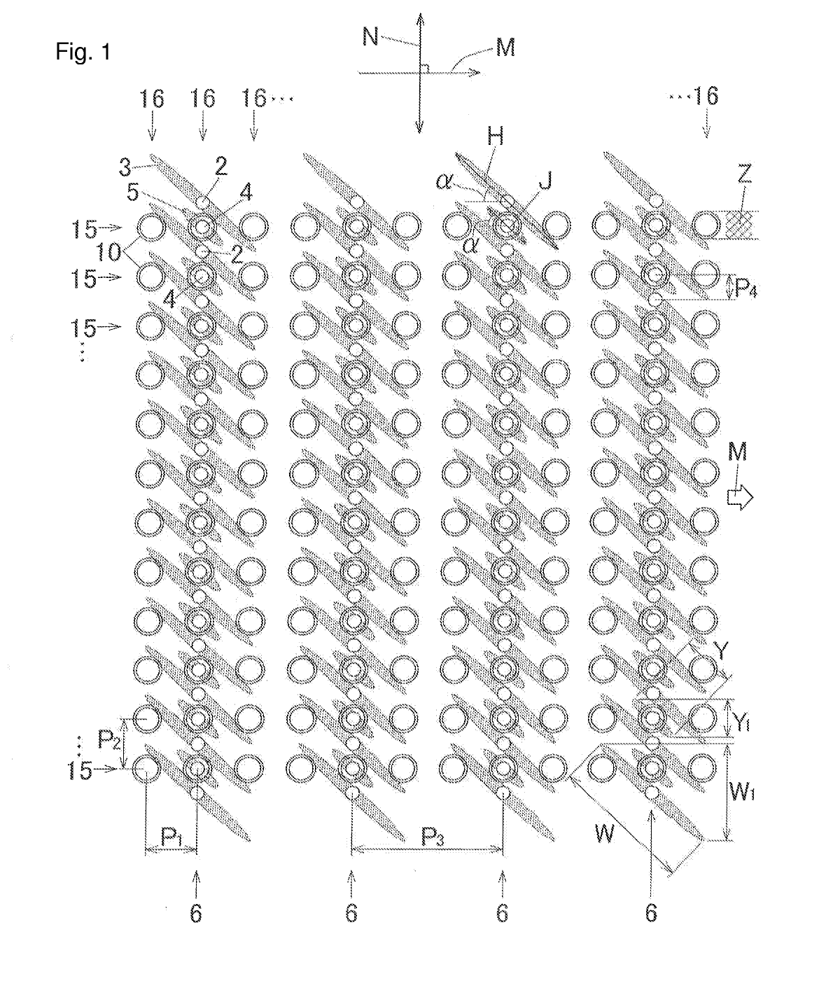

In FIG. 1, the reference numeral “1” denotes a cleaning device according to an embodiment of the present invention, and “10” denotes a work.

As shown in FIG. 4, the work 10 is tubular, more specifically cylindrical, in shape. Specifically, the work 10 is a photoconductive drum substrate of aluminum or aluminum alloy, and the cross-sectional shape is circular. When cleaning the work 10, the work 10 is set with the axis Q arranged vertically.

To form an excellent organic photoconductor layer on an outer peripheral surface 10b of a photoconductive drum substrate as a work 10, the photoconductive drum substrate is cleaned using a cleaning device 1 of this embodiment, and thereafter an organic photoconductor layer is formed on the outer peripheral surface 10b. Through these steps, a photoconductive drum is produced. Chamfering has been performed on the peripheral edge portion of each axial end surface of the substrate by cutting. For this reason, on each end face of the substrate, chips (not illustrated) generated by the chamfering work are adhered. Furthermore, in some cases, chips are adhered also to the outer peripheral surface and/or the inner peripheral surface of the substrate, and machining oil or working lubricant, etc., is adhered to each of the end face, the outer peripheral surface 10b, and the inner peripheral surface 10d of the substrate. For the purpose of removing adhered substances such as chips, oils, etc., a photoconductive drum substrate is subjected to a cleaning process by a cleaning method using the cleaning device 1 of this embodiment.

The work 10 has an outer diameter (diameter) “U” of, for example, 10 to 50 mm, and a thickness “t” of, for example, 0.5 to 2.0 mm.

The cleaning device 1 of this embodiment is configured to perform spray cleaning of a plurality of works 10 collectively, and is equipped with a work supporting member 7 that collectively supports a plurality of works 10, a plurality of upper nozzles 2, a plurality of lower nozzles 4, a driving means 8, etc.

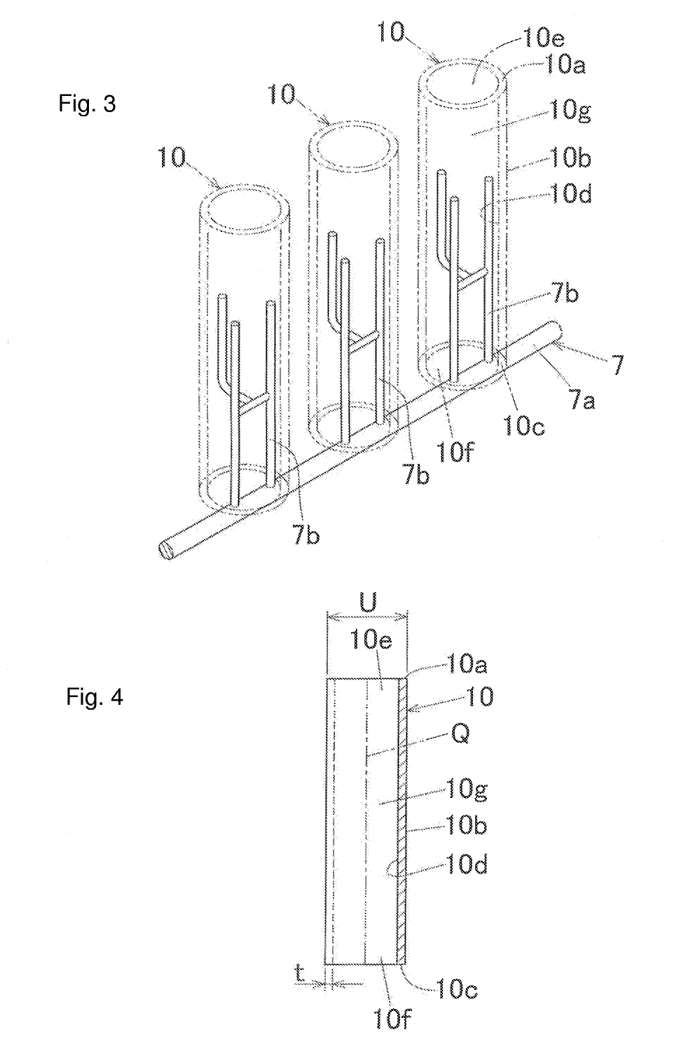

As shown in FIG. 3, the work supporting member 7 includes a horizontally arranged bar-shaped work placing portion 7a and a plurality of bar-shaped work holding portion 7b upwardly extended from the work placing portion 7a. The work placing portion 7a is circular in cross-section. The work 10 is placed on the work placing portion 7a with the axis Q arranged vertically. The work supporting portion 7b is configured to hold the posture of the work 10 so as not to fall over by inserting the work supporting portion 7b into the hollow portion 10g of the work 10 disposed with the axis Q arranged vertically from the lower end opening 10f of the work 10. The work 10 is placed on the work placing portion 7a in a state in which the work supporting portion 7b is inserted into the hollow portion 10g from the lower end opening 10f of the work 10, so that the work 10 is supported by the work supporting member 7 with the axis Q arranged vertically. In this state in which the work 10 is supported, the lower surface 10c of the work 10 is in a linear contact with the work placing portion 7a, and the lower end opening 10f of the work 10 is not fully closed by the work placing portion 7a, or is opened in the downward direction. Further, the upper end opening 10e of the work 10 opens in the upward direction. The diameter of the work placing portion 7a is set to be smaller than the inner diameter of the work 10, and is set, for example, so as to fall within the range of 0.6 to 0.8 times the inner diameter of the work 10. It should be noted that the work supporting member 7 is no illustrated in FIG. 1.

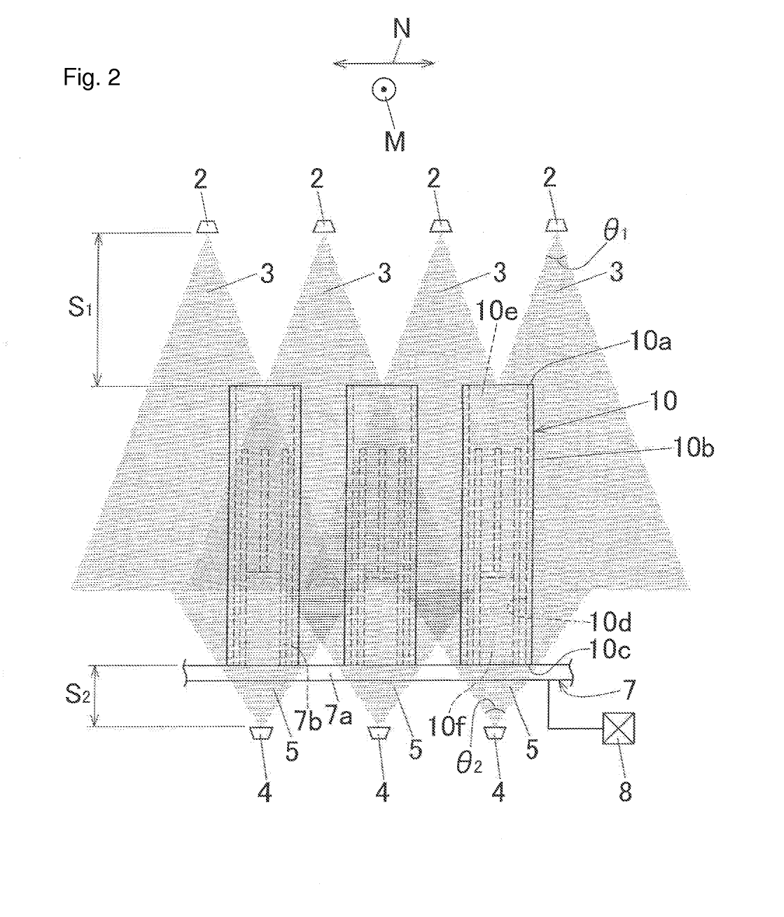

As shown in FIG. 2, the upper nozzle 2 is arranged on the upper side of the work 10 and configured to spout a cleaning liquid 3 downward. In this specification, the cleaning liquid 3 spouted from the upper nozzle 2 is called an “upper cleaning liquid 3”. The lower nozzle 4 is arranged on the lower side of the work 10 and configured to spout the cleaning liquid 5 upward. In this specification, the cleaning liquid 5 spouted from the lower nozzle 4 is called a “lower cleaning liquid 5”.

The upper cleaning liquid 3 hits against the upper surface 10a, the outer peripheral surface 10b, and the inner peripheral surface 10d (specifically, the upper portion of the inner peripheral surface 10d) of the work 10 to clean these surfaces 10a, 10b, and 10d. The lower cleaning liquid 5 hits against the lower surface 10c and the inner peripheral surface 10d (specifically, the lower portion of the inner peripheral surface 10d) of the work 10 to clean these surfaces 10c and 10d. The inner peripheral surface 10d of the work 10 is cleaned with the upper cleaning liquid 3 introduced into the hollow portion 10g of the work 10 from the upper end opening 10e of the work 10 and the lower cleaning liquid 5 introduced into the hollow portion 10g of the work 10 from the lower end opening 10f of the work 10.

The upper cleaning liquid 3 and the lower cleaning liquid 5 each are water, degreasing agent, etc., and the temperature is set within the range between, for example, 40 to 70° C. In the embodiment, the arranged positions of the upper nozzle 2 and the lower nozzle 4 are each fixed.

Furthermore, the upper nozzle 2 is constituted by a flat spray nozzle for spouting the upper cleaning liquid 3 in a fan-shaped film-like manner. Similarly, the lower nozzle 4 is constituted by a flat spray nozzle for spouting the lower cleaning liquid 5 in a fan-shaped film-like manner.

The driving means 8 is for collectively moving a plurality of works 10 in one horizontal direction M, and includes an electric actuator, a fluid pressure cylinder (e.g., hydraulic cylinder, gas cylinder), etc. Also, as shown in FIG. 2, this driving means 8 has a driving portion connected to the work supporting member 7 and is configured to move the work supporting member 7 supporting a plurality of works 10 in a predetermined direction M so that a plurality of works 10 are collectively moved in the predetermined direction M.

The cleaning device 1 of this embodiment is configured such that, in a state in which the upper cleaning liquid 3 and the lower cleaning liquid 5 are being spouted from the upper nozzle 2 and the lower nozzle 4, respectively, at least the upper surface 10a of the work 10 among the upper surface 10a of the work 10 and the outer peripheral surface 10b of the work 10 is cleaned with the upper cleaning liquid 3 and the lower surface 10c of the work 10 is cleaned with the lower cleaning liquid 5 by moving the work 10 in the predetermined direction M with the driving unit 8, and furthermore configured such that the upper cleaning liquid 3 and the lower cleaning liquid 5 are spouted from the upper nozzle 2 and the lower nozzle 4, respectively, so that when the lower cleaning liquid 5 hits against the lower surface 10c of the work 10, the upper cleaning liquid 3 always hits against at least a part of a region formed by the upper surface 10a of the work 10 and the outer peripheral surface 10b of the work 10. In this embodiment, the upper surface 10a and the outer peripheral surface 10b of the work 10 are cleaned with the upper cleaning liquid 3.

Next, the detailed structure of the cleaning device 1 of this embodiment will be explained.

As shown in FIG. 1, in a plane view, a plurality of works 10 are, at equal intervals, arranged in plural lines in the moving direction M of the works which are to be moved by the driving means 8 and arranged in plural lines in a direction N perpendicular to the moving direction M of the works, i.e., arranged in a matrix manner. In the matrix arrangement of the works, a work group in which a plurality of works 10 are arranged in a single line in the moving direction M of the works is denoted as a “work line 15” and a work group in which a plurality of works 10 are arranged in a single row in a direction N perpendicular to the moving direction M of the works is denoted as a “work row 16”. In the embodiment, there are a total of 12 of the work lines 15, and there are a total of 12 of the work rows 16. In other words, there are 12 lines and 12 rows. Therefore, the total number of works 10 is 144.

Furthermore, in this matrix work arrangement, a pitch P1 between the adjacent works 10 and 10 in the work line 15 and a pitch P2 between the adjacent works 10 and 10 in the work row 16 are set to be equal, and it is preferable that they are each set within the range of 1.5 to 2.5 times the outer diameter U of the work 10.

In a plane view, a plurality of the upper nozzles 2 and a plurality of the lower nozzles 4 are alternately arranged in a single row at equal intervals in the direction N perpendicular to the moving direction M of the works. Therefore, the arranged position of the upper nozzle 2 and the arranged position of the lower nozzle 4 are shifted in the direction N perpendicular to the moving direction M of the works. Furthermore, when a group of nozzles in which a plurality of upper nozzles 2 and the lower nozzles 4 are alternately arranged in a row is defined as a “nozzle row 6,” a plurality of the nozzle rows 6 are arranged at equal intervals in the moving direction M of the works. In the embodiment, the total number of the nozzle rows 6 is four (4).

In a plane view, a pitch P4 between the upper nozzle 2 and the lower nozzle 4 in the nozzle row 6 is set to be ½ times the pitch P2 between the adjacent works 10 and 10 in the work row 16. Furthermore, in a plane view, each lower nozzle 4 is arranged inside the moving region Z of the work moved by the driving means 8, and more specifically, each lower nozzle 4 is arranged at a middle position in the width direction inside the moving region Z of the work. On the other hand, in a plane view, each upper nozzle 2 is arranged outside the moving region Z of the work, and more specifically, each nozzle 2 is arranged in the middle position between two adjacent works 10 and 10 in the work row 16.

Also, a pitch P3 between the nozzle rows 6 and 6 of a plurality of rows (4 rows in the embodiment) is set within the range of 2 to 11 times the pitch P1 between the adjacent works 10 and 10 in the work line 15. In this embodiment, the pitch P3 is set to three times the pitch P1.

Each of the upper nozzle 2 and the lower nozzle 4 is arranged so that the spout spreading direction H of the upper cleaning liquid 3 spouted from each upper nozzle 2 and the spout spreading direction J of the lower cleaning liquid 5 spouted from each lower nozzle 4 are parallel to each other. In other words, each upper nozzle 2 and each lower nozzle 4 spout the upper cleaning liquid 3 and the lower cleaning liquid 5, respectively, so that the spout spreading direction H of the upper cleaning liquid 3 and the spout spreading direction J of the lower cleaning liquid 5 are parallel to each other. As explained above, in a plane view, since the arranged position of the upper nozzle 2 and the arranged position of the lower nozzle 4 are shifted in the direction N perpendicular to the moving direction M of the works, when the upper cleaning liquid 3 and the lower cleaning liquid 5 are spouted from the upper nozzle 2 and the lower nozzle 4, respectively, the upper cleaning liquid 3 and the lower cleaning liquid 5 do not directly interfere with each other, i.e., the upper cleaning liquid 3 and the lower cleaning liquid 5 do not directly hit against each other.

Furthermore, the upper cleaning liquid 3 and the lower cleaning liquid 5 are spouted from the upper nozzle 2 and the lower nozzle 4, respectively, so that the spout spreading directions H and J of the upper cleaning liquid 3 and the lower cleaning liquid 5 are oblique with respect to the moving direction M of the works. The angle α of the spout spreading direction H of the upper cleaning liquid 3 and the angle α of the spout spreading direction J of the lower cleaning liquid 5 with respect to the moving direction M of the works are each preferably set within the range of 25 to 80°. More specifically, the angles α and α are both set to, for example, 45°.

The spout flow amount V1 of the upper cleaning liquid 3 to be spouted from each upper nozzle 2 per unit time is set to be larger than the spout flow amount V2 of the lower cleaning liquid 5 to be spouted from each lower nozzle 4 per unit time (V1>V2). It is preferable that V1 is set to be within the range of 1.5 to 3.0 times V2. Specifically, V1 is, for example, set to be 4.5 to 39 L/min, and V2 is, for example, set to be within the range of 3 to 13 L/min.

As shown in FIG. 2, the spout spreading angle θ1 of the upper cleaning liquid 3 spouted from each upper nozzle 2 is set to be smaller than the spout spreading angle θ2 of the lower cleaning liquid 5 spouted from each lower nozzle 4 (θ1<θ2). It is preferable that θ2 is set to be within the range of 1.2 to 3.2 times θ1. Specifically, θ1 is, for example, set within the range of 25 to 65° and θ2 is, for example, set between the range of 40 to 80°.

Furthermore, the vertical directional distance S2 between the lower nozzle 4 and the work 10 is set to be shorter than the vertical directional distance S1 between the upper nozzle 2 and the work 10 (S2<S1). It is preferable that S1 is set to be within the range of 3 to 7 times S2. Specifically, S2 is, for example, set to be within the range of 10 to 45 mm, and S1 is, for example, set to be within the range of 70 to 150 mm.

In this way, S2 is set to be shorter than S1, and in other words, S1 is set to be longer than S2. As a result, as shown in FIG. 1, in a plane view, the spout spreading width W of the upper cleaning liquid 3 spouted from each upper nozzle 2 at the work arranged position is set to be larger than the spout spreading width Y of the lower cleaning liquid 5 spouted from the lower nozzle 4 at the work arranged position.

In detail, the length W1 of the spout spreading width W of the upper cleaning liquid 3 in the direction N perpendicular to the moving direction M of the works is set to be 2 times or more (more specifically, within the range of 2 to 3 times) the length of the pitch P2 between works 10 and 10 in the work row 16. With this setting, when the work 10 is moved in the predetermined direction M in a state in which the upper cleaning liquid 3 is being spouted from the upper nozzle 2, the upper cleaning liquid 3 hits against the upper surface 10a, the outer peripheral surface 10b, and the inner peripheral surface 10d (specifically, the upper portion of the inner peripheral surface 10d) of at least one (one or two in the embodiment) work 10 in one of the two adjacent work lines 15 and 15, and the upper surface 10a, the outer peripheral surface 10b and the inner peripheral surface 10d (specifically, the upper portion of the inner peripheral surface 10d) of at least one (one or two in the embodiment) work 10 in the other work line 15, and the entire surface of the upper surface 10a, the entire surface of the outer peripheral surface 10b, and the entire surface of the inner peripheral surface 10d (specifically, the entire surface of the upper portion of the inner peripheral surface 10d) of the work 10 are cleaned with the upper cleaning liquid 3 by the movement of the work 10.

On the other hand, the length Y1 of the spout spreading width Y of the lower cleaning liquid 5 in the direction N perpendicular to the moving direction M of the works is set to be equal to or longer than the outer diameter U of the work 10, i.e., longer than (specifically, within the range of 1 to 1.8 times) the pitch P2 between works 10 and 10 in the work row 16. With this setting, as shown in FIG. 2, when the work 10 is moved in the predetermined direction M in a state in which the lower cleaning liquid 5 is being spouted from the lower nozzle 4, the lower cleaning liquid 5 hits against the lower surface 10c and the inner peripheral surface 10d (specifically, the lower portion of the inner peripheral surface 10d) of the work 10 in the work line 15, and the entire surface of the lower surface 10c and the entire surface of the inner peripheral surface 10d (specifically, the entire surface of the lower portion of the inner peripheral surface 10d) of the work 10 are cleaned with the lower cleaning liquid 5 with the movement of the work 10.

The moving speed of the work 10 by the driving means 8 is, for example, within the range of 8 to 50 mm/s. The moving distance of the work 10 is set to be equal to or longer than twice the length of the pitch P1 between the works 10 and 10 in the work line 15, and preferably set within the range of P1×2 (two times P1) to P1×3 (3 times P1).

The pitch P4 between the upper nozzle 2 and the lower nozzle 4 in the nozzle row 6, and the angles α and α of the spout spreading directions H and J of the upper cleaning liquid 3 and the lower cleaning liquid 5 with respect to the moving direction M of the works are set so that, when the lower cleaning liquid 5 hits against the lower surface 10c of the work 10, in a plane view, at least one of the upper cleaning liquids 3 and 3 spouted from two upper nozzles 2 and 2 arranged on both sides of the lower nozzle 4 spouting the lower cleaning liquid 5 hits against at least a part of a region formed by the upper surface 10a of the work 10 and the outer peripheral surface 10b of the work 10.

Next, a cleaning method for works 10 using the cleaning device 1 of this embodiment is explained.

As shown in FIG. 3 with chain double-dashed lines, a plurality of works 10 are arranged such that the works are supported by the work supporting member 7 of the cleaning device 1 with the axes Q arranged vertical. In a plane view, the plurality of works 10 are arranged in a matrix arrangement manner in which a plurality of works are arranged in a plurality of lines and in a plurality of rows in the moving direction M of the works and in the direction N perpendicular to the moving direction M.

Next, the upper cleaning liquid 3 is spouted downward in a fan-shaped film-like manner from each upper nozzle 2 of the cleaning device 1, and the lower cleaning liquid 5 is spouted upward in a fan-shaped film-like manner from each lower nozzle 4. While maintaining this state, a plurality of works 10 are collectively moved in the predetermined direction M via the wok supporting member 7 using the driving means 8.

As a result, as shown in FIG. 1, the upper cleaning liquid 3 hits against the upper surface 10a, the outer peripheral surface 10b, and the inner peripheral surface 10d (specifically, the upper portion of the inner peripheral surface 10d) of at least one (one or two in the embodiment) work 10 of one of the work lines 15 among the two adjacent work lines 15 and 15, and the upper surface 10a, the outer peripheral surface 10b, and the inner peripheral surface 10d (specifically, the upper portion of the inner peripheral surface 1d) of at least one (one or two in the embodiment) work 10 of the other work line 15. With the movement of the work 10, the entire surface of the upper surface 10a, the entire surface of the outer peripheral surface 10b, and the entire surface of the inner peripheral surface 10d (specifically, the entire upper surface portion of the inner peripheral surface 10d) of the work 10 are cleaned by the upper cleaning liquid 3. At the same time, the lower cleaning liquid 5 hits against the lower surface 10c and the inner peripheral surface 10d (specifically, the lower portion of the inner peripheral surface 10d) of one work 10 in the work line 15. With the movement of the work 10, the entire surface of the lower surface 10c and the inner peripheral surface 10d (specifically, the entire surface of the lower portion of the inner peripheral surface 10d) of the work 10 are cleaned by the lower cleaning liquid 5. The aforementioned step is denoted as a “cleaning step”.

At this cleaning step, when the lower cleaning liquid 5 hits against the lower surface 10c of the work 10, in a plane view, at least one of the upper cleaning liquids 3 and 3 spouted from the two upper nozzles 2 and 2 arranged on both sides of the lower nozzle 4 spouting the lower cleaning liquid 5 hits always against at least a part of a region formed by the upper surface 10a of the work 10 and the outer peripheral surface 10b of the work 10. Therefore, the work 10 can be prevented from having the trouble of rising up from the hitting force (collision force) of the lower cleaning liquid 5 to the lower surface 10c. In this way, the lower surface 10c of the work 10 can be assuredly cleaned, and further, possible damages to the lower surface 10c of the work 10 which may be caused by collision of the lower surface 10c of the work 10 to the work placing portion 7a of the work supporting member 7 can be prevented.

Furthermore, by spouting the upper cleaning liquid 3 and the lower cleaning liquid 5 from the upper nozzle 2 and the lower nozzle 4, respectively, so that the upper cleaning liquid 3 and the lower cleaning liquid 5 do not interfere with each other, the detergency of the upper cleaning liquid 3 and that of the lower cleaning liquid 5 can be improved.

Furthermore, since the spout flow amount V1 of the upper cleaning liquid 3 to be spouted from the upper nozzle 2 per unit time is larger than the spout flow amount V2 of the lower cleaning liquid 5 to be spouted from the lower nozzle 4, the work 10 can be assuredly prevented from rising up.

Furthermore, the work 10 is tubular (specifically, cylindrical) in shape, and is placed with the axis Q arranged vertically, and at the cleaning step, the upper surface 10a, the outer peripheral surface 10b, the inner peripheral surface 10d (specifically, the lower portion of the inner peripheral surface 10d) of the work 10 are cleaned with the upper cleaning liquid 3, and the lower surface 10c and the inner peripheral surface 10d (specifically, the upper portion of the inner peripheral surface 10d) of the work 10 are cleaned with the lower cleaning liquid 5. In this way, even if the work 10 is a tubular member (cylindrical member) having a small diameter, the entire surface of the work 10, i.e., the upper surface 10a, the outer peripheral surface 10b, the lower surface 10c, and the inner peripheral surface 10d of the work 10, can be cleaned.

Furthermore, the upper nozzle 2 and the lower nozzle 4 are each constituted by a flat spray nozzle, and at the cleaning step, the upper cleaning liquid 3 and the lower cleaning liquid 5 are spouted from the upper nozzle 2 and the lower nozzle 4, respectively, in a fan-shaped film-like manner. For that reason, the hitting force of the upper cleaning liquid 3 and that of the lower cleaning liquid 5 to the work 10 are larger than a hitting force of a cleaning liquid spouted to the work 10 from a full cone spray nozzle. Therefore, the detergency of the upper cleaning liquid 3 and that of the lower cleaning liquid 5 each can be improved.

Furthermore, since the upper cleaning liquid 3 and the lower cleaning liquid 5 are spouted from the upper nozzle 2 and the lower nozzle 4, respectively, so that the spout spreading direction H of the upper cleaning liquid 3 and the spout spreading direction J of the lower cleaning liquid 5 become parallel with each other, the interference of the upper cleaning liquid 3 and the lower cleaning liquid 5 can be assuredly prevented, and furthermore, the upper cleaning liquid 3 and the lower cleaning liquid 5 can be spouted in a closely arranged manner to effectively clean the work 10, and the cleaning device 1 can be reduced in size.

Also, in a plane view, a plurality of works 10 are arranged in a direction N perpendicular to the moving direction M of the works, and a plurality of upper nozzles 2 and lower nozzles 4 are arranged alternatively in a direction N perpendicular to the moving direction M of the works 10, so a plurality of works 10 can be cleaned collectively.

Furthermore, in a plane view, since the upper nozzle 2 is arranged outside the moving region Z of the work, and the lower nozzle 4 is arranged inside the moving region Z of the work, the upper surface 10a and the outer peripheral surface 10b of the work 10 can be cleaned assuredly with the upper cleaning liquid 3, and even if the work 10 is a tubular member (cylindrical member) having a small diameter, the lower surface 10c, and the inner peripheral surface 10d of the work 10 can be assuredly cleaned with the lower cleaning liquid 5.

Furthermore, at the cleaning step, in a plane view, since the upper cleaning liquid 3 and the lower cleaning liquid 5 are spouted from the upper nozzle 2 and the lower nozzle 4, respectively, so that both the spout spreading direction H of the upper cleaning liquid 3 and the spout spreading direction J of the lower cleaning liquid 5 become oblique with respect to the moving direction M of the works, in cases where a plurality of works 10 are arranged in the direction N perpendicular to the moving direction M of the works, two adjacent works 10 and 10 can be cleaned with the upper cleaning liquid 3 spouted from one upper nozzle 2. This enables effective cleaning of the work 10.

Furthermore, in a plane view, a plurality of works 10 are arranged in plural lines in the moving direction M of the works and arranged in plural rows in the direction N perpendicular to the moving direction M of the works, and at the cleaning step, since the upper cleaning liquid 3 is spouted so that upper cleaning liquid 3 hits against at least one of the works 10 in one of the work lines 15 among two adjacent work lines 15 and 15, and at least one work 10 in the other work line 15, more works 10 can be cleaned collectively, resulting in more effective cleaning of works 10.

Also, since the spout spreading width W of the upper cleaning liquid 3 to be spouted from the upper nozzle 2 at the work arranged position is larger than the spout spreading width Y of the lower cleaning liquid 5 to be spouted from the lower nozzle 4 at the work arranged position, a spouting condition of the upper cleaning liquid 3 and that of the lower cleaning liquid 5 can be assuredly attained in such a manner that the upper cleaning liquid 3 and the lower cleaning liquid 5 are spouted from the upper nozzle 2 and the lower nozzle 4, respectively, so that the upper cleaning liquid 3 always hits against at least a part of a region formed by the upper surface 10a of the work 10 and the outer peripheral surface 10b of the work 10 when the lower cleaning liquid 5 hits against the lower surface 10c of the work 10.

Furthermore, since the vertical directional distance S2 between the lower nozzle 4 and the work 10 is shorter than the vertical directional distance S1 between the upper nozzle 2 and the work 10, the lower surface 10c of the work 10 can be assuredly cleaned.

Also, since the work 10 is a photoconductive drum substrate, a photoconductive drum substrate as a work 10 can be cleaned. In particular, since the substrate as a work 10 is arranged with its axis arranged vertical and both end surfaces in the axial direction of the substrate become the upper surface and the lower surface, both end surfaces of the substrate to which chips are adhered can be assuredly cleaned to assuredly eliminate the chips.

An embodiment of the present invention has been explained above, however, the present invention is not limited to the aforementioned embodiment, and can be changed in various ways.

For example, in the aforementioned embodiment, the work 10 is cleaned with a method in which the work 10 is moved in a state in which the arranged positions of the upper nozzle 2 and the lower nozzle 4 are fixed. In the present invention, however, another method can be employed, in which the work 10 is cleaned by moving the upper nozzle 2 and the lower nozzle 4 in a state in which the arranged position of the work 10 is fixed.

In the present invention, the work 10 can be something other than a photoconductive drum substrate.

This application claims priority to Japanese Patent Application No. 2010-118371 filed on May 24, 2010, and the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

### INDUSTRIAL APPLICABILITY

The present invention can be used for a cleaning method and a cleaning device for cleaning a work, such as, e.g., a photoconductive drum substrate.

### DESCRIPTION OF THE REFERENCE NUMERALS

1: cleaning device
2: upper spray nozzle
3: upper cleaning liquid
4: lower spray nozzle
5: lower cleaning liquid
6: nozzle row
7: work supporting member
10: work
10a: upper surface
10b: outer peripheral surface
10c: lower surface
10d: inner peripheral surface
15: work line
16: work row
M: moving direction of the work
N: direction perpendicular to the moving direction of the work
Z: moving region of the work
S1: vertical directional distance between the upper nozzle and the work
S2: vertical directional distance between the lower nozzle and the work

1. A cleaning method comprising:
a cleaning step of, in a state in which an upper cleaning liquid is spouted downward from an upper nozzle arranged on an upper side of a work and a lower cleaning liquid is spouted upward from a lower nozzle arranged on a lower side of the work, cleaning at least an upper surface of the work among the upper surface of the work and an outer peripheral surface of the work with the upper cleaning liquid and cleaning a lower surface of the work with the lower cleaning liquid by relatively moving the work in a horizontal direction with respect to both the upper nozzle and the lower nozzle, wherein
at the cleaning step, the upper cleaning liquid and the lower cleaning liquid are spouted from the upper nozzle and the lower nozzle, respectively, so that the upper cleaning liquid always hits against at least a part of a region formed by the upper surface of the work and the outer peripheral surface of the work when the lower cleaning liquid hits against the lower surface of the work.

2. The cleaning method as recited in claim 1, wherein
an arranged position of the upper nozzle and an arranged position of the lower nozzle are shifted in a plane view; and
at the cleaning step, the upper cleaning liquid and the lower cleaning liquid are spouted from the upper nozzle and the lower nozzle, respectively, so that the upper cleaning liquid and the lower cleaning liquid do not interfere with each other.

3. The cleaning method as recited in claim 1, wherein
a spout flow amount of the upper cleaning liquid to be spouted from the upper nozzle per unit time is larger than a spout flow amount of the lower cleaning liquid to be spouted from the lower nozzle per unit time.

4. The cleaning method as recited in claim 1, wherein
the work is a cylindrical member and is arranged with an axis thereof arranged vertically; and
at the cleaning step, the upper surface, the outer peripheral surface and an inner peripheral surface of the work are cleaned with the upper cleaning liquid, and the lower surface and the inner peripheral surface of the work are cleaned with the lower cleaning liquid.

5. The cleaning method as recited in claim 1, wherein:
the upper nozzle and the lower nozzle are each constituted by a flat spray nozzle; and
at the cleaning step, the upper cleaning liquid and the lower cleaning liquid are spouted from the upper nozzle and the lower nozzle, respectively, in a fan-shaped film-like manner.

6. The cleaning method as recited in claim 5, wherein
at the cleaning step, the upper cleaning liquid and the lower cleaning liquid are spouted from the upper nozzle and the lower nozzle, respectively, so that a spout spreading direction of the upper cleaning liquid and a spout spreading direction of the lower cleaning liquid become parallel with each other in a plane view.

7. The cleaning method as recited in claim 5, wherein
in a plane view, a plurality of works are arranged in a direction perpendicular to a relative moving direction of the works; and
in a plane view, a plurality of upper nozzles and a plurality of lower nozzles are arranged alternatively in the direction perpendicular to the relative moving direction of the works.

8. The cleaning method as recited in claim 5, wherein
in a plane view, the upper nozzle is arranged outside a relative moving region of the work, and the lower nozzle is arranged inside the relative moving region of the work.

9. The cleaning method as recited in claim 5, wherein
at the cleaning step, in a plane view, the upper cleaning liquid and the lower cleaning liquid are spouted from the upper nozzle and the lower nozzle, respectively, so that both a spout spreading direction of the upper cleaning liquid and a spout spreading direction of the lower cleaning liquid become oblique with respect to the relative moving direction of the works.

10. The cleaning method as recited in claim 5, wherein
in a plane view, a plurality of the works are arranged in plural lines in the relative moving direction of the works and arranged in plural rows in the direction perpendicular to the relative moving direction of the works; and
at the cleaning step, the upper cleaning liquid is spouted so that the upper cleaning liquid hits against at least one work arranged in one of the adjacent two work lines and at least one work arranged in the other of the adjacent two work lines.

11. The cleaning method as recited in claim 5, wherein
a spout spreading width of the upper cleaning liquid to be spouted from the upper nozzle at the work arranged position is larger than a spout spreading width of the lower cleaning liquid to be spouted from the lower nozzle at the work arranged position.

12. The cleaning method as recited in claim 1, wherein
a vertical directional distance between the lower nozzle and the work is shorter than a vertical directional distance between the upper nozzle and the work.

13. The cleaning method as recited in claim 1, wherein
the work is a photoconductive drum substrate.

14. A cleaning device comprising:
an upper nozzle arranged on an upper side of a work and configured to spout an upper cleaning liquid downward;
a lower nozzle arranged on a lower side of the work and configured to spout a lower cleaning liquid upward; and
a driving means configured to move the work in a horizontal direction relative to both the upper and lower nozzles; wherein
it is configured such that in a state in which an upper cleaning liquid is spouted from the upper nozzle and a lower cleaning liquid is spouted from the lower nozzle, at least an upper surface of the work among the upper surface of the work and an outer peripheral surface of the work are cleaned with the upper cleaning liquid and a lower surface of the work is cleaned with the lower cleaning liquid by relatively moving the work with respect to the upper nozzle and the lower nozzle with the driving means; and
the upper cleaning liquid and the lower cleaning liquid are spouted from the upper nozzle and the lower nozzle, respectively, so that the upper cleaning liquid always hits against at least a part of a region formed by the upper surface of the work and the outer peripheral surface of the work when the lower cleaning liquid hits against the lower surface of the work.
